(19) United States
(12) Patent Application Publication
(10) Pub. No.: US 2026/0080906 A1
(43) Pub. Date: Mar. 19, 2026

(54) FAILSAFE POWER MANAGEMENT TO AVOID SHORT-CIRCUITING FROM WATER DAMAGE IN SOLID STATE DRIVE USING CONDUCTIVITY DETECTOR

(71) Applicant: Sandisk Technologies, Inc., Milpitas, CA (US)

(72) Inventor: Sankalp Dubey, Bangalore (IN)

(21) Appl. No.: 18/890,025

(22) Filed: Sep. 19, 2024

(51) Int. Cl. G11B 33/10; G06F 9/4401

(52) U.S. Cl. CPC G11B 33/10; G06F 9/442

(57) ABSTRACT

Methods and apparatus are provided for detecting the presence of electrically-conducting liquids within a data storage device such as an M.2 solid state device (SSD) and for triggering a failsafe mode. In an illustrative example, the SSD includes a non-volatile memory (NVM) array and data storage controller. A linear resistive strip or other resistivity sensor is mounted adjacent to the NVM array and the data storage controller. A conductivity detector detects the presence of an electrically-conducting liquid using the linear resistive strip. A power management unit (PMU) activates a failsafe processing mode in response to the detection of the electrically-conducting liquid. In the failsafe mode, power is disabled to the NVM array and data storage controller to prevent corrosion and short-circuiting. A signal is also sent to a laptop or other host in which the SSD is installed to request shutdown of the laptop.

### FIELD

The subject matter described herein relates to data storage devices and controllers. More particularly, the subject matter relates, in some examples, to techniques for preventing a short circuit within a solid-state data storage device due to water damage.

### INTRODUCTION

Data storage devices (DSDs), such as solid-state devices (SSDs), may suffer water damage, leading to short-circuiting, corrosion, and metal layer damage within the DSD. For example, condensation of water within an SSD containing a NAND die or a data storage controller may suffer these problems. More specifically, the condensation of water on ball grid arrays (BGAs) (e.g., for the NAND die or data storage controller) implemented on a printed circuit board (PCB) of a NAND-based SSD may lead to corrosion between the NAND die and its BGA pins or between a data storage processor and its BGA pins. Similar problems may arise with other surface mount packages (SMPs). This increases the risk of hardware damage and data loss. This can be a significant problem within in-built M.2 SSDs that are installed as components of laptops. M.2 is a specification for internally mounted computer expansion cards and associated connectors, and M.2 SSDs are peripheral component interconnect express (PCIe) native devices and originally designed to plug into a laptop or desktop personal computer's (PC's) M.2 internal slots. Such laptops often have numerous vents for cooling and airflow around the laptop motherboard, processor, and circuitry, which may allow water or moist air into the in-built M.2 SSD within the laptop, resulting in corrosion within the SSD.

In many cases, the data stored in the SSD is much more valuable to the user than the SSD itself. For example, state-of-the-art SSDs may store terabytes of data, including millions of project files, financial records, or other confidential and valuable data. Protecting SSDs from water damage is thereby particularly important to protect the stored data. Such protection is especially challenging with M.2 form factor SSDs due to their small size and thin profile. At least some aspects of the present disclosure are directed to mitigating the risk of water-related damage and loss of data in such devices or to achieving other goals.

### SUMMARY

The following presents a simplified summary of some aspects of the disclosure to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

One aspect of the disclosure provides a data storage device (DSD) that includes: a non-volatile memory (NVM) array mounted on a Printed Circuit Board (PCB) using a first surface mount package (SMP); one or more processors mounted on the PCB using a second SMP and in communication with the NVM array; a sensor mounted adjacent to one or both of the first SMP and the second SMP; a detector configured to detect an electrically-conducting liquid using the sensor; and wherein the one or more processors are configured, individually or in combination, to activate a failsafe processing mode in response to the detection of the electrically-conducting liquid.

Another aspect of the disclosure provides a DSD that includes: an NVM array mounted to a printed circuit board (PCB); a resistive strip mounted to the PCB; a conductivity detector coupled to the resistive strip; and one or more processors configured, individually or in combination, to: receive signals from the conductivity detector indicating whether an amount of metal ions in a liquid touching the resistive strip exceeds an impurity threshold; deactivate a power supply of the data storage device in response to the amount of metal ions in the liquid exceeding the impurity threshold; and reactivate the power supply in response to the amount of metal ions in the liquid subsequently no longer exceeding the impurity threshold.

Yet another aspect of the disclosure provides a data storage device that includes: means for detecting aqueous metal ions within the data storage device; means determining whether the aqueous metal ions exceed an impurity threshold; means for deactivating a power supply of the data storage device in response to the aqueous metal ions exceeding the impurity threshold; and means for reactivating the power supply in response to the aqueous metal ions no longer exceeding the impurity threshold.

### BRIEF DESCRIPTION OF THE DRAWINGS

FIG. 1 is a schematic block diagram illustrating an exemplary data storage device (DSD) embodied as a solid-state device (SSD) including one or more resistive strip sensors and other components for detecting the presence of electrically-conducting liquid within the DSD using the resistive strips, in accordance with some aspects of the disclosure.

FIG. 2 illustrates selected components of an exemplary M.2 SSD, in accordance with some aspects of the disclosure.

FIG. 3 illustrates a physical configuration of an exemplary M.2 SSD, in accordance with some aspects of the disclosure.

FIG. 4 illustrates a NAND array die with a ball grid array (BGA) showing resistive strips mounted adjacent to the BGA of the NAND die, in accordance with some aspects of the disclosure.

FIGS. 5A and 5B illustrate an exemplary procedure that may be performed by an SSD for detecting and responding to an electrically-conducting liquid within the SSD, in accordance with some aspects of the disclosure.

FIG. 6 illustrates an exemplary procedure that may be performed by an SSD for converting electrical resistance signals to conductivity values for comparison against conductivity thresholds to detect electrically-conducting liquids within the SSD, in accordance with some aspects of the disclosure.

FIG. 7 is a schematic block diagram illustrating an exemplary data storage device configured, in accordance with some aspects of the disclosure.

FIG. 8 is a schematic block diagram illustrating another exemplary data storage device configured, in accordance with some aspects of the disclosure.

FIG. 9 is a schematic block diagram illustrating yet another exemplary data storage device configured, in accordance with some aspects of the disclosure.

FIG. 10 is a flowchart illustrating a method or procedure for use by a DSD or an SSD, in accordance with some aspects of the disclosure.

### DETAILED DESCRIPTION

In the following detailed description, reference is made to the accompanying drawings, which form a part thereof. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

The examples herein relate to data storage devices (DSDs) and to data storage controllers of the DSDs. In the main examples described herein, data is stored within non-volatile memory (NVM) arrays. DSDs with NVM arrays may be referred to as solid state devices (SSDs) or flash drives. Some SSDs use NAND memory, herein referred to as “NANDs.” A NAND is a type of non-volatile storage technology that does not require power to retain data. It exploits negative-AND, i.e., NAND, logic. For the sake of brevity, an SSD having one or more NAND dies will be used as a non-limiting example of a DSD in the description of various embodiments. In particular, a NAND SSD with an M.2 form factor is used as an example. It is understood that at least some aspects described herein may be applicable to other forms of DSDs as well. For example, at least some aspects described herein may be applicable to DSDs with phase-change memory (PCM) arrays, magneto-resistive random access memory (MRAM) arrays, and resistive random access memory (ReRAM) arrays. In still other examples, data may be stored in hard disk drives (HDD).

### Overview

As discussed above, SSDs may suffer water damage which can lead to short-circuiting, corrosion, and metal layer damage within the SSD. For example, condensation of water in ball grid arrays (BGAs) of a printed circuit board (PCB) within an SSD may lead to corrosion between the NAND array die and its BGA pins or between the data storage controller and its BGA pins, increasing the risk of hardware damage and resulting data loss. Similar problems may arise with other surface mount packages (SMPs). This is especially a problem within in-built M.2 SSDs that are used as components of laptops.

There are some relatively expensive techniques that seek to protect PCBs from water damage, such as the use of conformal coatings, water-proofing layers, manual sprays, dipping processes, or closed enclosures. These methods can have various drawbacks. For example, coatings and enclosures add additional costs based on the PCB area, which needs specialized material, selective sprays, selection flow, protection, or vapor application. Coatings to SSD parts can be very difficult to remove, making them much more difficult to clean and repair in the case of rework, which adds to the manual cost of reworking and reapplying coating. If all the routing is coated, significant problems can arise when component issues need debugging. There are also environmental and safety regulations to consider with SSDs. Coating chemicals must be used only in accordance with local regulations. The SSD may fail to gain the proper licenses for import/export or sale if the SSD is not deemed safe for the environment.

Herein, a failsafe power management mechanism is provided for use in M.2 SSDs or other DSDs. In illustrative examples, the failsafe mechanism includes an intelligent power management device (which may be referred to as a “PMU IP” or just as a “PMU”), a programmable power relay, a linear resistive strip sensor, and a conductivity detector to detect electrically-conducting liquids around one or more SMPs of the SSD. The PMU cuts off power to the NAND die and data storage controller if electrically-conducting liquids are detected.

Not all liquids are electrically-conducting. Only those liquids that are electrically-conducting pose a significant risk of corrosion or short-circuiting within the SSD. Such liquids include metal ions or other impurities that conduct electricity. Accordingly, the conductivity detector is configured to detect the presence of metal ions or other impurities in the liquid to distinguish a non-conducting (and non-harmful) liquid from a potentially harmfully electrically-conducting liquid. In some aspects, the failsafe mechanism is only activated upon detection of electrically-conducting liquid with sufficient conductivity to present a significant risk of damage. In other examples, the failsafe mechanism can be activated upon detection of any amount of liquid.

In some aspects, the conductivity detector collects and analyzes various parameters to detect an electrically-conducting liquid in the SSD and sends a signal to the PMU to turn off (or on) a programmable power relay that turns off (or on) power to specific modules such as the NAND array die and data storage controller. In some aspects, the procedure involves coordination and synchronization of the PMU with the data storage controller to send/receive requests and acknowledgments to/from the laptop (or other host) so that the PMU provides enough time to pause receiving data packets and request a safe shutdown of the laptop by sending an interrupt request (IRQ). The procedure thereby protects the NAND array die and the data storage controller from damage or short-circuiting, and thereby also protects data stored in the NAND array. The SSD can also be equipped with an internal Li-ion battery to provide power to the failsafe mode circuitry, which helps to re-enable power delivery to the NAND and controller.

These and other features are described more fully below.

### Exemplary M.2 SSD and Failsafe Procedures

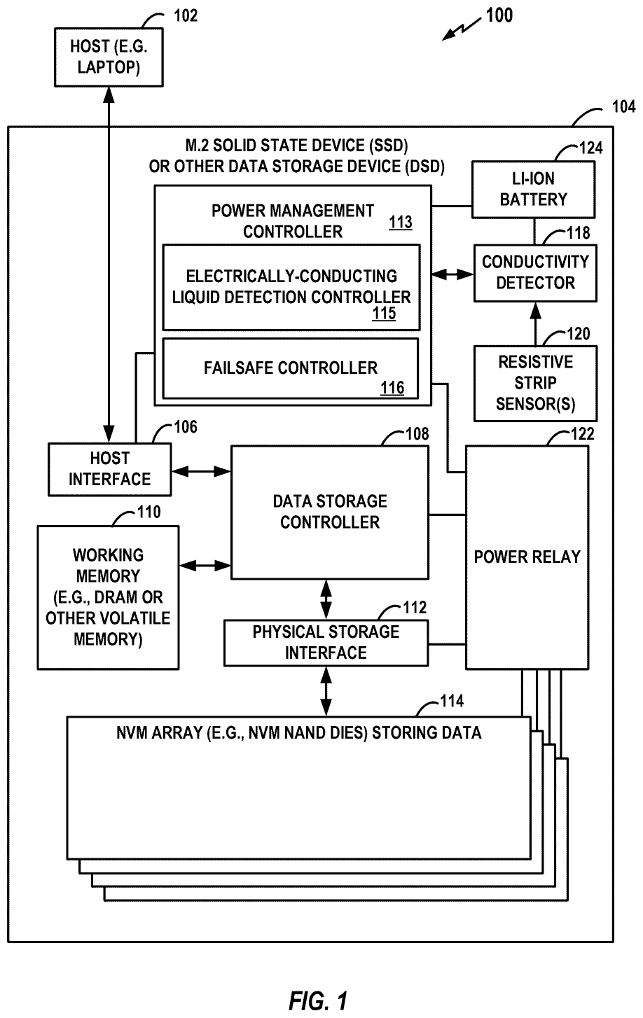

FIG. 1 is a schematic block diagram illustrating an exemplary DSD embodied as an SSD (e.g., an M.2 SSD) including one or more resistive strip sensors, a conductivity detector, and a power management controller (PMU) configured to activate and control a failsafe mode in response to the detection of electrically-conducting liquid (e.g., ionized water) within the SSD in accordance with some aspects of the disclosure. System 100 includes a host 102 and the SSD 104 (or other DSD, but for simplicity, it is referred to as an SSD herein) coupled to host 102. The host 102 provides commands to the SSD 104 for transferring data between the host 102 and the SSD 104. For example, the host 102 may provide a write command to the SSD 104 for writing data to the SSD 104 or a read command to the SSD 104 for reading data from the SSD 104. The host 102 may be any system or device needing data storage or retrieval and a compatible interface for communicating with the SSD 104. For example, the host 102 may be a computing device, a personal computer, a portable computer, a workstation, a server, a personal digital assistant, a digital camera, or a digital phone as merely a few examples. In the primary examples herein, the host is a laptop in which the SSD is installed.

The SSD 104 includes a host interface 106, a data storage controller 108, a working memory 110 (such as dynamic RAM (DRAM) or other volatile memory), a physical storage (PS) interface 112 (e.g., flash interface module (FIM)), and an NVM array 114 having one or more NAND dies storing data. The host interface 106 is coupled to the data storage controller 108 and facilitates communication between the host 102 and the data storage controller 108. The data storage controller 108 is coupled to the working memory 110 as well as to the NVM array 114 via the PS interface 112. The host interface 106 may be any suitable communication interface, such as a Non-Volatile Memory express (NVMe) interface, a Universal Serial Bus (USB) interface, a Serial Peripheral (SP) interface, an Advanced Technology Attachment (ATA) or Serial Advanced Technology Attachment (SATA) interface, a Small Computer System Interface (SCSI), an IEEE 1394 (Firewire) interface, or the like. In some embodiments, the host 102 includes the SSD 104. In other embodiments, the SSD 104 is remote from the host 102 or is contained in a remote computing system communicatively coupled with the host 102. For example, the host 102 may communicate with the SSD 104 through a wireless communication link. The NVM array 114 may include multiple dies.

Although, in the example illustrated in FIG. 1, SSD 104 includes a single channel between data storage controller 108 and NVM array 114 via PS interface 112, the subject matter described herein is not limited to having a single memory channel. For example, in some NAND memory system architectures, two, four, eight, or more NAND channels couple the controller and the NAND memory device, depending on controller capabilities. In any of the embodiments described herein, more than a single channel may be used between the controller and the memory die, even if a single channel is shown in the drawings. The data storage controller 108 may be implemented in a single integrated circuit chip and may communicate with different layers of memory in the NVM 114 over one or more command channels.

The data storage controller 108 controls the operation of the SSD 104. In various aspects, the data storage controller 108 receives commands from the host 102 through the host interface 106 and performs the commands to transfer data between the host 102 and the NVM array 114. Furthermore, the data storage controller 108 may manage reading from and writing to working memory 110 for performing the various functions affected by the controller and to maintain and manage cached information stored in the working memory 110.

The data storage controller 108 may include any type of processing device, such as a microprocessor, a microcontroller, an embedded controller, a logic circuit, software, firmware, or the like, for controlling the operation of the SSD 104. In some aspects, some or all of the functions described herein as being performed by the data storage controller 108 may instead be performed by another element of the SSD 104. For example, the SSD 104 may include a microprocessor, a microcontroller, an embedded controller, a logic circuit, software, firmware, ASIC, or any kind of processing device, for performing one or more of the functions described herein as being performed by the data storage controller 108. According to other aspects, one or more of the functions described herein as being performed by the data storage controller 108 are instead performed by the host 102. In still further aspects, some or all of the functions described herein as being performed by the data storage controller 108 may instead be performed by another element such as a controller in a hybrid drive including both non-volatile memory elements and magnetic storage elements.

The primary power supply of the SSD 104 is the host 102, which delivers power to the SSD 104 (via a suitable power connection, not shown). A power relay 122 relays the power from the host 102 to various components such as the data storage controller 108 and the NVM array 114. The SSD 104 includes a power management controller (e.g., PMU) 113 that includes, in this example, an electrically-conducting liquid detection controller 115 and a short circuit failsafe controller 116. The electrically-conducting liquid detection controller 115 is configured to receive signals from a conductivity detector 118, which is connected to one or more resistive strip sensors 120 (e.g., linear resistive strips). The electrically-conducting liquid detection controller 115 detects the presence of an electrically-conducting liquid within the SSD 104 based on information provided by the conductivity detector 118. (In some examples, the conductivity detector 118 is configured to detect the electrically-conducting liquid and notify the power management controller 113. In other examples, the power management controller 113 may also receive signals directly from the strip sensor 120.)

Upon detection of electrically-conducting liquid within the SSD, the short circuit failsafe controller 116 may disconnect (or disable or deactivate) power from the host 102 to prevent possible short circuits within the SSD 104. This may be accomplished by controlling the power relay 122. If the primary power is disconnected, a backup Li-ion battery 124 may be used as a secondary power supply to continue to provide sufficient power so that at least some components of the device (e.g., the power management controller 113 and the conductivity detector 118) can continue to operate to detect the subsequent drying of the liquid so that the primary power can be reactivated. For example, the detector may be configured to detect the amount of electrically-conducting liquid decreasing below a threshold indicative of sufficient drying. In some aspects, the power management controller 113 and the conductivity detector 118 may be implemented using any combination of hardware, software, and firmware (e.g., like the implementation options described above for SSD controller 108).

The resistive strip sensors 120 are shown in block diagram form in FIG. 1, but it should be understood that these components may be placed directly adjacent to particular hardware components of the SSD 104, such as the data storage controller 108 and the NVM array 114. Although not shown in FIG. 1, the data storage controller 108 and the NVM array 114 may be mounted to a PCB via BGAs (or other SMPs) with the resistive strips installed adjacent to those BGAs to detect liquid on or near the BGAs that might cause corrosion and/or a short circuit. Also note that the power management controller 113 is shown connected to the host interface 106 since, in some examples, the power management controller 113 sends signals to the host 102 to request a laptop shutdown if electrically-conducting liquids are detected within the SSD 104 (so that the laptop may, for example, shut down until the liquid dries out).

The working memory 110 may be any suitable memory, computing device, or system capable of storing data. For example, working memory 110 may be ordinary RAM, DRAM, double data rate (DDR) RAM, static RAM (SRAM), synchronous dynamic RAM (SDRAM), a flash storage, an erasable programmable Read Only-memory (EPROM), an electrically erasable programmable ROM (EEPROM), or the like. In various embodiments, the controller 108 uses the working memory 110, or a portion thereof, to store data during the transfer of data between the host 102 and the NVM array 114. For example, the working memory 110 or a portion of the volatile memory 110 may be a cache memory. The NVM array 114 receives data from the controller 108 via the PS interface 112 and stores the data. In some embodiments, working memory 110 may be replaced by a non-volatile memory such as MRAM, PCM, ReRAM, etc. to serve as a working memory for the overall device.

The NVM array 114 may be implemented using NAND flash memory. In one aspect, the NVM array 114 may be implemented using any combination of NAND flash, PCM arrays, MRAM arrays, and/or ReRAM. In one example, six NAND flash chips are provided. The PS interface 112 provides an interface to the NVM array 114. For example, in the case where the NVM array 114 is implemented using NAND flash memory, the PS interface 112 may be a flash interface module. In one aspect, the PS interface 112 may be implemented as a component of the SSD controller 108.

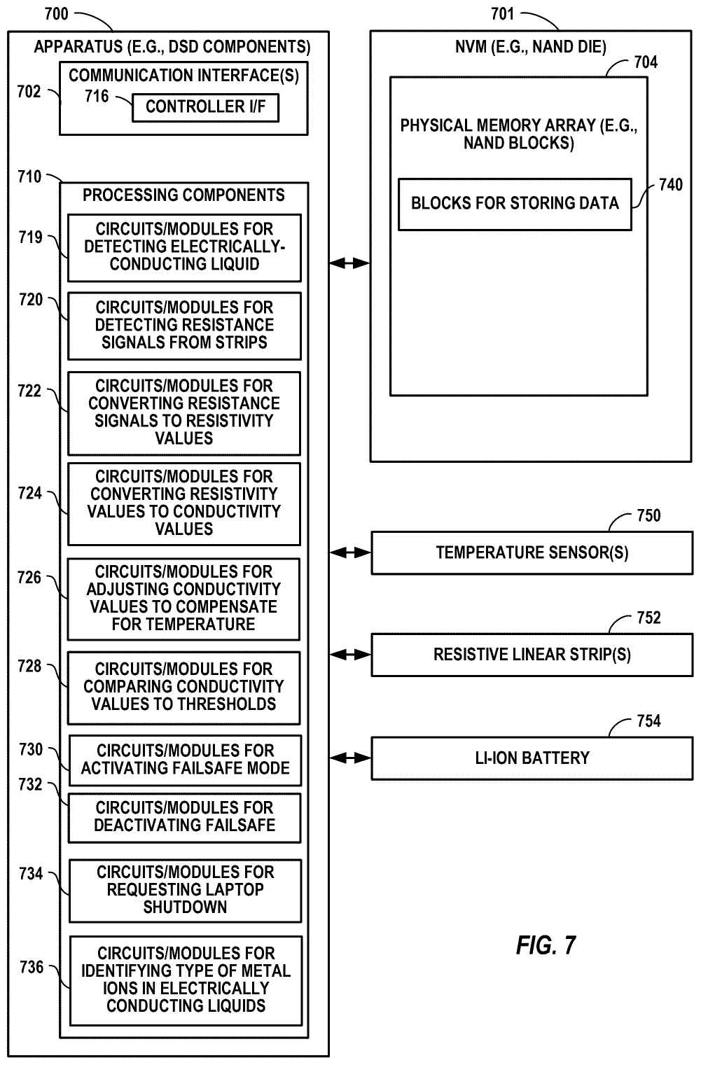

Although not shown in FIG. 1, in some examples a temperature sensor is provided in the SSD 104 to enable temperature compensation of conductivity measurements made by the conductivity detector 118. A temperature sensor is shown in FIG. 7, discussed below.

Although FIG. 1 shows an exemplary SSD which is used as an illustrative example in the description throughout, the various disclosed embodiments are not necessarily limited to an SSD application/implementation. As an example, the disclosed NVM array and associated processing components can be implemented as part of a package that includes other processing circuitry and/or components. For example, a processor may include, or otherwise be coupled with, an embedded NVM array and associated circuitry. The processor could, as one example, offload certain operations to the NVM and associated circuitry and/or components. As another example, the SSD controller 108 may be a controller in another type of device and still be configured to perform some or all of the other functions described herein.

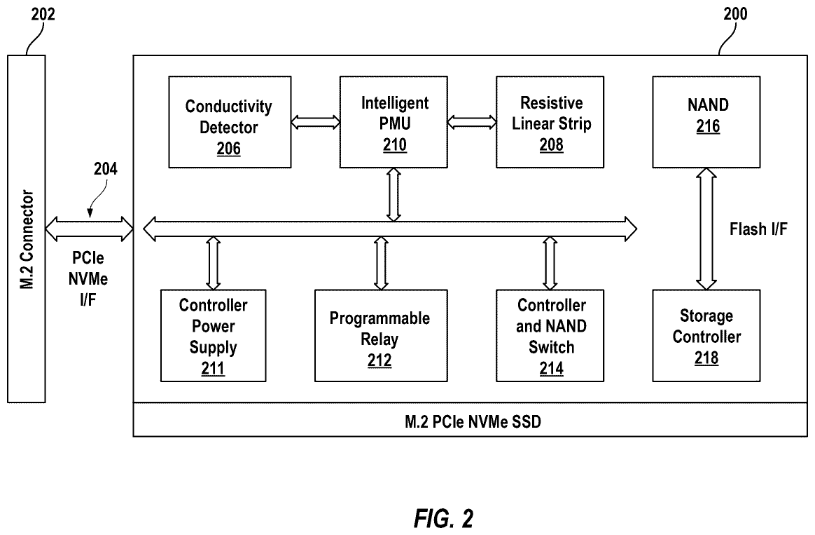

FIG. 2 illustrates selected components of an exemplary M.2 SSD 200 configured to communicate with an M.2 connector 202 (which may be a component of a laptop in which the SSD 200 is installed), wherein the communication exploits peripheral component interconnect express (PCIe) and NVMe via a PCIe NVMe interface (I/F) bus 204. As shown, the SSD 200 includes a conductivity detector 206 and a resistive linear strip 208. An intelligent PMU 210 is provided, which may correspond with the power management controller 113 of FIG. 1. The SSD 200 also includes a controller power supply 211 (which may receive power from the host), a programable relay 212, and a controller and NAND switch 214. Still further, the SSD 200 includes a NAND 216 (which may correspond to the NVM array 114 of FIG. 1) and a storage controller (which may correspond to the data storage controller 108 of FIG. 1). The components of the SSD 200 are interconnected using various buses shown in the figure but not separately numbered. Also, note that in some examples the conductivity detector 206 is connected directly to the resistive linear strip 208 to receive voltage signals directly from the resistive linear strip 208. The resistive linear strip 208 is shown in block diagram form in FIG. 2, but it should be understood that the resistive linear strip 208 may be placed directly adjacent to particular hardware components of the SSD 200, such as the NAND 216 and the storage controller 218.

With this configuration, the conductivity detector 206 detects electrically-conducting liquids within the SSD 200 using the resistive linear strip 208 and signals the PMU 210, which can then cut off power (from power supply 211) and/or control power delivery to selected components, such as the NAND 216 and the storage controller 218. If power is to be cut off, the PMU 210 sends a signal to the programmable relay 212 to turn off power to specific modules such as NAND 216 and storage controller 218. The PMU 210 may also send/receive requests and acknowledgments to/from the host via connector 202 to provide enough time to pause the reception of data packets and request a safe shutdown of the host (laptop) by sending IRQ. In this manner, the NAND 216 and data storage controller 218 may be protected from severe damage or short-circuiting, which also protects data stored in the NAND. As shown in FIG. 1, the SSD may be equipped with an internal Li-ion battery to provide power to various components such as the PMU 210 and conductivity detector 206 to re-enable power delivery to the NAND and controller once the SSD is again dry. A temperature sensor also may be provided to enable temperature compensation of conductivity measurements.

In some examples, power can be disabled to the NAND 216 and the storage controller 218 if an active signal is received by the PMU 210 from the resistive strip 208 signaling a voltage above a programmable threshold voltage to indicate the presence of liquid (e.g., water present near BGA pins of the NAND 216 and the storage controller 218). In some examples, the PMU 210 also receives signals from the conductivity detector 206 indicating the presence (or absence) of metallic ions in the liquid. Power is disabled only if the liquid has a high level of ions (impurities) indicating a significant risk of short circuit. For example, signals from the conductivity detector 206 may be compared against suitable conductivity thresholds.

In some aspects, the PMU 210 operates to turn off the NAND 216, enable failsafe power management procedures, enter a critical mode or failsafe mode, and then wait for water to dry near the BOA pins. In some examples, the PMU 210 is always operating (along with the conductivity detector 206 and the resistive strip 208) to make decisions in real time. Continuous voltage changes and measurements may be recorded, with analog-to-digital conversion (ADC) values synchronized to the PMU 210.

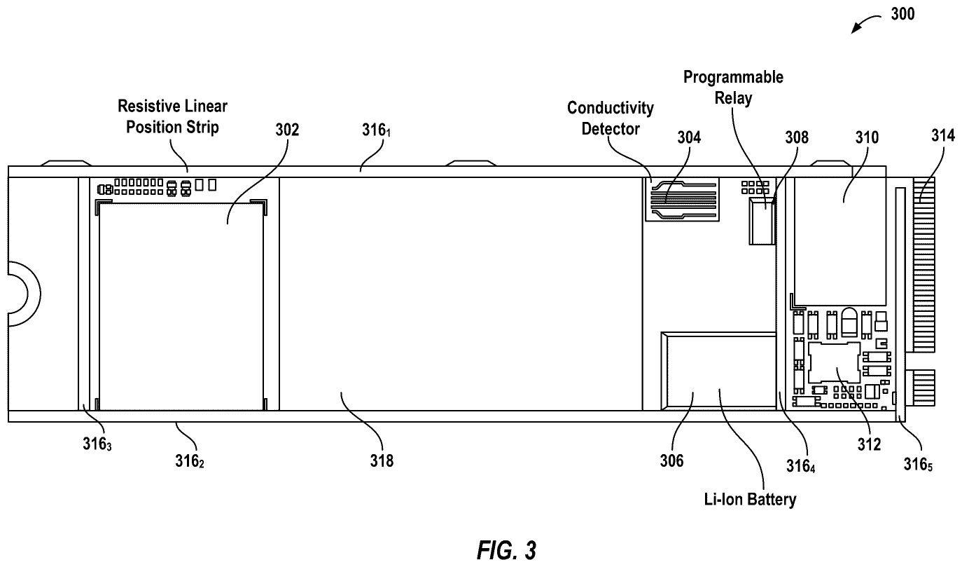

FIG. 3 illustrates an M.2 SSD 300 showing selected components. The SSD 300 includes a NAND chip 302 (or NVM array), a conductivity detector 304, a Li-ion battery 306, a programmable relay 308, a data storage controller 310, other electrical components 312, and a connector 314. A first resistive linear strip 316₁ extends along a first edge of the SSD from a distal end (near NAND 302) to a proximal end (near data storage controller 310). Resistive linear strip 316₁ passes close alongside a portion of the data storage controller 310 to detect moisture in its vicinity. Resistive linear strip 316₁ is also coupled to conductivity detector 304 to permit the conductivity detector 304 to input and process signals received from the resistive strip to detect water and assess impurities. A second resistive linear strip 316₂ extends along an opposing second edge side of the SSD and passes close alongside a portion of NAND 302 to detect moisture in its vicinity. A third resistive linear strip 316₃ is coupled between strips 316₁ and 316₂ and extends along a side of NAND 302 to detect any moisture along that side of the NAND. By being coupled to both strips 316₁ and 316₂, strip 316₃ allows signals to be conducted from 316₂ to the conductivity detector 304 via strip 316₁. A fourth resistive linear strip 316₄ is coupled between strips 316₁ and 316₂ and extends along a side of the data storage controller 310 to detect any moisture along that side of the data storage controller. A fifth resistive linear strip 316₅ is coupled to strip 316₂ and extends along another side of the data storage controller 310 to detect any moisture along that side of the data storage controller.

In other examples, more or fewer strips may be provided. Note that in the example of FIG. 3, there is unused space 318 within the middle of the SSD to accommodate additional NAND chips (so the SSDs can provide additional memory). For example, two additional NAND chips could be installed in the available space). Additional strips may be provided that pass alongside those additional NAND chips to permit the detection of moisture in the vicinity of the additional NAND chips.

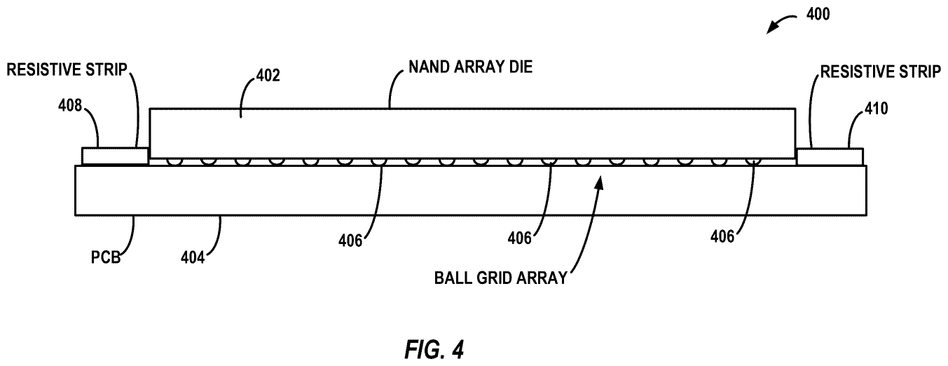

FIG. 4 illustrates a side view of a portion of an SSD 400 showing the positioning of resistive strips adjacent to the BGA of a NAND array die. Briefly, the SSD 400 includes a NAND array die 402 mounted to a PCB 404 via a BGA composed of solder balls 406. A first resistive strip 408 is mounted to the PCB 404 adjacent to a first side of the NAND array die 402 to sense moisture in the vicinity of the BGA along that side of the NAND array die. A second resistive strip 410 is mounted to the PCB 404 adjacent to an opposing second side of the NAND array die 402 to sense moisture in the vicinity of the BGA along that side of the NAND array die. More or fewer strips may be provided. For example, although not shown, additional strips may be provided along the other two sides of the square NAND array die. Note also that, if moisture works its way under a chip into the BGA, at least some of that moisture will be along the side edges of the chip and hence detectable by a resistive strip adjacent to the chip. As such, it is often sufficient to have just one strip adjacent to the chip. More strips can be used to provide more thorough moisture detection.

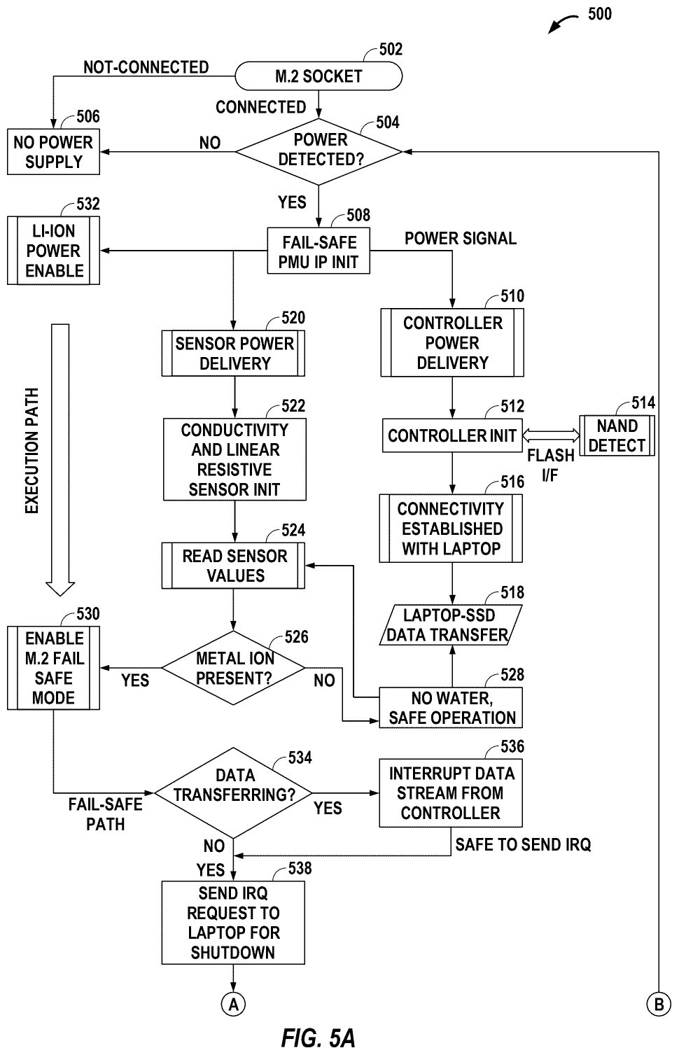

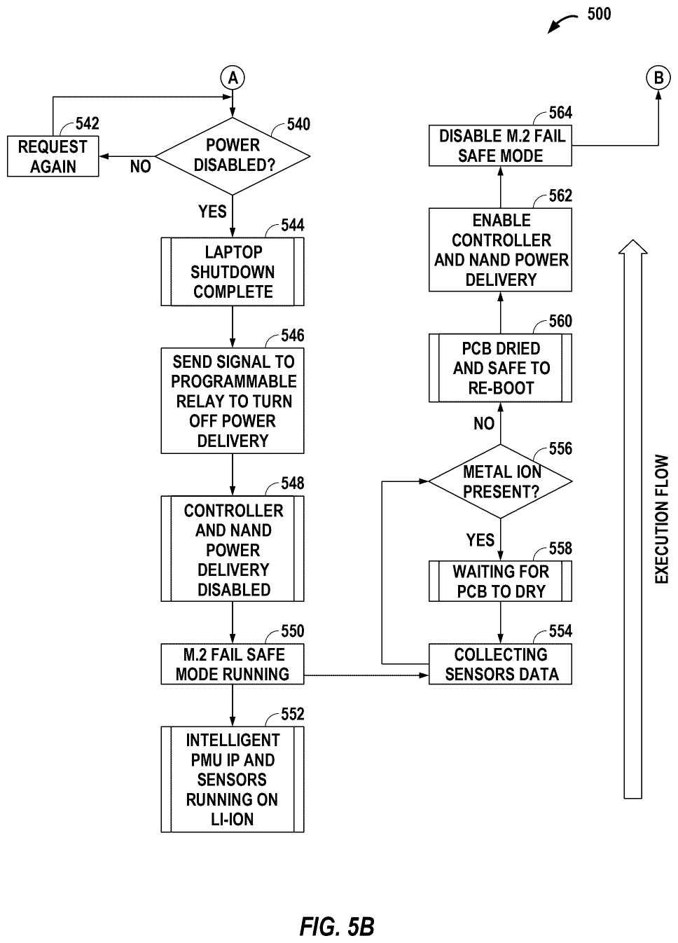

FIGS. 5A and 5B provide a flow diagram illustrating an exemplary procedure 500 that may be performed by a suitably-equipped SSD such as the M.2 SSD of FIG. 1 or 2. Beginning at an M.2 socket stage 502, the M.2 SSD determines whether it is connected into the socket of a host device, such as a laptop computer and, if so, then at 504 the SSD detects whether power is being provided by the host device. If no power is detected, then, as indicated by block 506, there is no adequate power supply for operating the data storage controller and NAND array die and so processing does not proceed. (Note that the power referred to here is power provided by the host and not power provided by the additional Li-ion battery within the SSD to power some SSD components during the failsafe mode.)

Assuming power is detected at block 504, the failsafe intelligent PMU (e.g. PMU 210 of FIG. 2) is initialized at 508 and a power signal is sent (e.g. from the PMU 210 to the power supply controller 211 of FIG. 2) to control power delivery to the data storage controller (e.g., controller 218 of FIG. 2) at block 510. The data storage controller is initialized at 512, which also triggers activation to the NAND chip (e.g., NAND 216 of FIG. 2) at 514 via NAND detect procedure. The NAND detect serves to verify and activate the NAND. Connectivity is established with the laptop at 516 and laptop-SSD data transfer may be performed at 518.

Concurrently, following initialization of the PMU at block 508, power is delivered by the PMU to the conductivity detector/sensor at 520 and the conductivity and linear resistive sensor components are initialized at 522 (e.g., detector 206 of FIG. 2 is initialized). Values from the conductive detector/sensor are read by the PMU at 524. If metal ions are not detected (or no moisture at all is detected) at block 526, safe operation is permitted as indicated by block 528. If metal ions are present within detected moisture, the failsafe mode is activated at block 530. Note that, following block 508, the PMU also enables the Li-ion power supply at block 532 to enable operation of the PMU and the conductivity detector/sensor during the failsafe mode. Note also that blocks 520-528 may be performed before blocks 510-518 to ensure the safe operation of the data storage controller and NAND chip. That is, the PMU operates to verify there is no electrically-conducting liquid before power is applied to the data storage controller and NAND chip.

If the failsafe mode is activated at block 530, the PMU determines whether data is currently being transferred to/from the host at 534. If data is being transferred, the transfer is interrupted at block 536. Thereafter, it is safe to send a IRQ to shut down the laptop. The IRQ is sent to the laptop at block 538 to request laptop shutdown. Laptop shutdown is requested since, if moisture is detected within the M.2 SSD inside the laptop, other components of the laptop may also have moisture and so a full laptop shutdown is warranted. If the laptop shuts itself down, power supply from the laptop to the SSD is disabled, as detected at block 540. If the power has not yet been disabled, the IRQ shutdown request is resent to the laptop at block 542. Eventually, power is disabled and the laptop shutdown is complete at block 544. A signal is sent at block 546 to the program relay (e.g., relay 212 of FIG. 2) to turn off power delivery to the data storage controller and NAND. Power delivery to the data storage controller and NAND is then disabled at block 548. Note here that, although power delivery from the laptop has already been disabled (as detected at block 540), it is nevertheless worthwhile to control the relay 212 to also disable power to the data storage controller and NAND. This is done so that if the laptop again begins to deliver power to the SSD during the failsafe mode, that power will not be routed to the data storage controller and NAND, possibly damaging those devices.

The failsafe mode continues to run at block 550. During the failsafe mode, the PMU and the conductive/resistive detectors/sensors continue to run using power from the Li-ion battery at block 554 to collect data to determine whether moisture with metal ions is still present. That is, the conductivity detector continues to run during the failsafe mode. Assuming liquid with metal ions is still detected as determined at block 556, the PMU continues to wait for the PCB to dry at block 558. Once the PCB is dry, it is safe to reboot the SSD at 560. At block 562, power delivery is reenabled to the data storage controller and the NAND. At block 564, the failsafe mode is disabled. Processing returns to 504 to resume normal operations.

### Conductivity Assessment Procedure

As explained above, the conductivity detector (e.g., detector 304 of FIG. 3) is connected to at least one resistive strip (e.g., strips 316 of FIG. 3) and configured to detect an electrically-conducting liquid. In some examples, the conductivity detector may also identify the presence of aqueous metal ions within acids, bases, and salts. To this end, the conductivity detector coordinates the timing and sequencing of measurements when resistivity changes in or around the resistive strip. The conductivity detector may also include an inbuilt data filter to remove noise from raw ADC data to ensure more accurate measurements. Note that the metal ions may also be referred to as impurities.

In an exemplary procedure, resistance values (R) are received by the conductivity detector from the resistive strips. Resistivity values (ρ) are computed from the resistance values (R). Conductivity values (σ) are then computed from the resistivity values (ρ). The conductivity values (σ) are compared to one or more conductivity thresholds to detect the presence of metal ions or other impurities. More specifically, in some examples, the conductivity values are processed to identify ions due to salts (such as sodium chloride), acids (such as hydrochloric acid), and bases (such as sodium hydroxide). If the values exceed the threshold(s), metal ions are thereby detected and the failsafe mode is activated. Otherwise, normal operations are performed (i.e., the SSD remains in a working state). Note that many aqueous solutions do not have conductivity. For example, non-electrolyte solutions such as sugar or ethanol do not conduct electricity because they lack sufficient ions. Therefore, in some aspects, the failsafe mode is not activated merely upon the detection of any liquid. It is activated upon detection of a potentially harmful level of metal ions that can cause corrosion, short-circuiting, or other issues. (In other aspects, as already noted, the failsafe can be activated upon the detection of any water regardless of the level of ions within the water.)

In some examples, the following impurities can be analyzed:

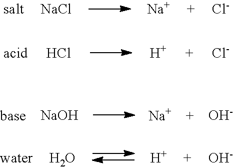

The detection procedure may be programmed to enable the conductivity detector to automatically compensate for temperature variations by adjusting either the conductivity values or the threshold values. Verification procedures may be performed following fabrication of a test SSD to verify that the sensor of the SSD is properly calibrated to detect metal ions. The threshold(s) or temperature compensation parameters may be adjusted as needed.

Herein, conductivity processing can involve the following processes and features:
Power Supply: The intelligent PMU activates and supplies power to the resistive strip and conductivity detector when the SSD is connected to a laptop, ensuring the system is ready for measurement.
Continuous Measurement: The conductivity detector continuously monitors the changes in resistance of the resistive strip, detecting variations due to the presence of ions in the liquid detected near BGAs and near passive components.
ADC value conversion: The analog values of the resistive strip are converted to digital values using an inbuilt ADC in the conductivity detector for further processing.
Noise Filtering: The conductivity detector employs digital signal processing (DSP) techniques to filter out noise from the raw ADC data, ensuring more accurate resistance and conductance measurements.
Conductivity Calculation: The conductivity detector determines the conductivity (σ) of liquid within the SSD using the formula σ=1/ρ. The resistivity (ρ) is calculated using the formula ρ=R*A/L, where R is the resistance, A is the cross-sectional area of the resistive strip, and L is its length. This procedure exploits precise geometric calibration of the resistive strip and cell constant which is done during SSD design and manufacturing.
Temperature compensation: Since the conductivity of liquids increases with temperature, a temperature coefficient constant is used for accurate conductivity readings:

$$Adjusted Conductivity = ( σ / ( 1 + tc * ( temperature - 25. ) ) )$$

where, tc=temperature coefficient constant per degree Celsius and temperature=values read from on-board temperature sensors.
Ion Analysis: The conductivity detector analyzes the conductivity values to identify the presence of specific ions from salts, acids, and bases. This is achieved by comparing the measured values against preprogrammed (inbuilt) threshold values stored in conductivity detector's memory to enable detection of substances such as sodium chloride, hydrochloric acid, acetic acid and sodium hydroxide.
Threshold Comparison: The conductivity values are compared with predefined threshold values stored in the conductivity detector's memory. The comparison determines whether the solution is sufficiently conductive to pose a risk to SSD operation.
The results of the conductivity measurements and ion analysis are stored in an NVM of the conductivity detector for further processing. The sensor then sends a control signal to the PMU, which activates the programmable relay to disable power to the NAND array die and data storage controller to ensure the SSD operates safely once liquid detected.

Insofar as the cell constants is concerned, the cell constant K (known as conductivity probes or electrodes) refers to the ratio of the distance between the two conductive plates to their surface area. The constants are calculated for different liquids during calibration procedures conducted during product design and then stored in SSD memory for use by the conductivity detector. A cell constant uses the units of per centimeter (for example, 1/cm), where the value represents the ratio of the distance between the electrode plates (d) to the surface area of the plates (A). The cell constant may be measured as follows:
1. Conductivity probes are calibrated with standard solutions with known conductivity values.
2. The distance between probes (d) and the surface area (A) are measured using formula K=d/A.
3. The measured values are stored in SSD memory to use by the conductivity detector.

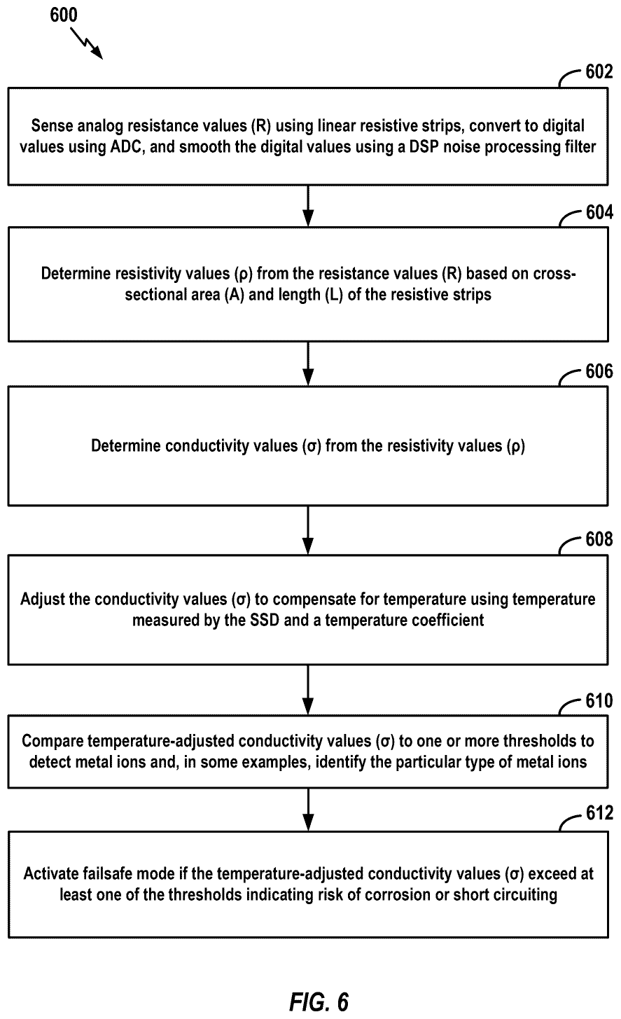

FIG. 6 illustrates some of these features. At block 602, the conductivity detector senses analog resistance values (R) using the linear resistive strips, converts the analog values to digital values using ADC, and smooths the digital values using a DSP noise processing filter. At block 604, the conductivity detector computes or otherwise determines resistivity values (ρ) from the resistance values (R) based on cross-sectional area (A) and length (L) of the resistive strip, as described above. At block 606, the conductivity detector computes or otherwise determines conductivity values (σ) from the resistivity values (ρ), as described above. At block 608, the conductivity detector adjusts the conductivity values (σ) to compensate for temperature using temperature measured by the SSD and a temperature coefficient, as described above. At block 610, the conductivity detector compares temperature-adjusted conductivity values (σ) to one or more conductivity thresholds to detect metal ions and, in some examples, identify the particular metal ions. (The conductivity thresholds may also be referred to as impurity thresholds.) At block 612, the conductivity detector sends a signal to the PMU to activate the failsafe mode if the temperature-adjusted conductivity values (σ) exceed at least one of the thresholds. Note that, in some examples, a single threshold is used and if the conductivity values exceed that threshold, the failsafe mode is activated. In other examples, multiple thresholds may be defined to allow the sensor to distinguish between different types of metal ions as discussed above. The detected metal ion type can be stored in memory.

The particular threshold values programmed into the conductivity detector of the SSD may be determined during SSD design by, e.g., applying liquids with known quantities of metal ions to the resistive strips within a test device and to the BGAs of the test device to assess the amount of corrosion or short circuiting while also reading out the corresponding measured conductivity values. Thresholds may then be set based on the measured conductivity values to trigger the failsafe mode to avoid any significant risk of corrosion or short circuiting. Note that the calibration procedure may be performed by also applying known quantities of different types of metal ions (bases, acids, etc.) to establish different thresholds for the different metal ions, if desired, to enable the device to identify the different types of metals ions. Note also that conductivity is expressed in units of Siemens per meter (S/m), while resistivity, which is the inverse of conductivity, is expressed in ohm-meters (Ω·m).

TABLE I provides exemplary conductivity and resistivity values for various fluids, which may be used to set the threshold values for detecting and distinguishing various metal ions. For example, pairs of threshold values may be programmed into the conductivity detector of the SSD with each pair of threshold values bracketing corresponding conductivity values of the table so that the conductivity detector may detect and identify the particular fluid. For instance, a first pair of threshold values may be set to bracket σ=0.0000055 S/m so that, if the measured conductivity falls between that first pair of threshold values, ultra-pure water is thereby detected (which is non-corrosive and therefore does not trigger the failsafe mode). In one particular example, the listed conductivity value may be bracketed using thresholds set to +10% and −10% of the listed value (or +20% and −20%, etc.) For fluids where a range of values are listed in the table, the lower threshold may be set below the lower conductivity value and the upper threshold may be set above the upper conductivity value. In cases where there might be some overlap between the thresholds for different fluids, the detector might not be capable of distinguishing between the different fluids but would still determine whether the conductivity level warranted triggering the fail-safe mode.

TABLE I

| Fluid | Conductivity (σ) | | Resistivity (ρ) | |
|---|---|---|---|---|
| Ultra-Pure Water | 0.0000055 | S/m | 180,000 | Ω · m |
| Drinking Water | 0.005-0.05 | S/m | 200-20 | Ω · m |
| Seawater | 4 | S/m | 0.25 | Ω · m |
| Acetic Acid (0.1M) | 0.0029 | S/m | 345 | Ω · m |
| Sulfuric Acid (0.1M) | 0.07 | S/m | 14.3 | Ω · m |
| Sodium Chloride | 1.0 | S/m | 1.0 | Ω · m |
| (NaCl, 0.1M) | | | | |
| Copper | 59,600,000 | S/m | 0.0000000168 | Ω · m |
| Aluminum | 37,700,000 | S/m | 0.0000000265 | Ω · m |
| Silicon (Intrinsic) | 0.00156 | S/m | 641 | Ω · m |
| Silver | 63,000,000 | S/m | 0.0000000159 | Ω · m |
| Graphite | 10,000-100,000 | S/m | 0.00001-0.0001 | Ω · m |

### Exemplary Data Storage Device

FIG. 7 illustrates an embodiment of an exemplary apparatus 700 configured according to one or more aspects of the disclosure. The apparatus 700, or components thereof, could embody or be implemented within a M.2 SSD having, one or more temperature sensors 750, one or more resistive linear strips 752, and a NAND die 701 or other type of NVM array that supports data storage. In various implementations, the apparatus 700, or components thereof, could be a component of a processor, a controller, a computing device, a personal (laptop) computer, a portable device, workstation, a server, a personal digital assistant, a digital camera, a digital phone, an entertainment device, a medical device, a self-driving vehicle control device, an edge device, or any other electronic device that stores, processes, or uses data. In particular, the apparatus may be a M.2 SSD installed in a laptop computer.

The apparatus 700 includes a communication interface 702 and is coupled to the NVM 701 (e.g., a NAND die). The NVM 701 includes physical memory array 704. The communication interface 702 is further coupled to the one or more temperature sensors 750 and the one or more resistive linear strips 752. These components can be coupled to and/or placed in electrical communication with one another via suitable components, represented generally by the connection line in FIG. 7. Although not shown, other circuits such as timing sources, peripherals, voltage regulators, and power management circuits may be provided, which will not be described any further. Note also that, as explained above, the resistive linear strips may be placed adjacent to a BGA of a NAND die and/or a BGA of a data storage controller of the DSD, and/or adjacent to other components of the SSD.

The communication interface 702 of the apparatus 700 provides a means for communicating with other apparatuses over a transmission medium. In some implementations, the communication interface 702 includes circuitry and/or programming (e.g., a program) adapted to facilitate the communication of information bi-directionally with respect to one or more devices in a system. In some implementations, the communication interface 702 may be configured for wire-based communication. For example, the communication interface 702 could be a bus interface, a send/receive interface, or some other type of signal interface including circuitry for outputting and/or obtaining signals (e.g., outputting signal from and/or receiving signals into a DSD).

The physical memory array 704 may include one or more NAND blocks 740. The physical memory array 704 may be accessed by the processing components 710. Some of the processing components 710 may be part of a data storage controller of the DSD; others may be separate components such as the above-described conductivity detector, PMU, etc.

In one aspect, the apparatus 700 may also include volatile memory for storing instructions and other information to support the operation of the processing components 710.

The apparatus 700 includes various processing components 710 arranged or configured to obtain, process and/or send data, control data access and storage, issue or respond to commands, and control other desired operations. For example, the processing components 710 may be implemented as one or more processors, one or more controllers, and/or other structures configured to perform functions. According to one or more aspects of the disclosure, the processing components 710 may be adapted to perform any or all of the features, processes, functions, operations and/or routines described herein that pertain to DSDs and SSDs. For example, the processing components 710 may be configured to perform any of the steps, functions, and/or processes described with respect to FIGS. 1, 2, 3, 4, 5A, 5B, 6, 8, 9, and 10. As used herein, the term “adapted” in relation to processing components 710 may refer to the components being one or more of configured, employed, implemented, and/or programmed to perform a particular process, function, operation and/or routine according to various features described herein. The circuits may include a specialized processor, such as an ASIC that serves as a means for (e.g., structure for) carrying out any one of the operations described, e.g., in conjunction with FIGS. 1, 2, 3, 4, 5A, 5B, 6, 8, 9, and 10. The processing components 710 serve as an example of a means for processing. In various implementations, the processing components 710 may provide and/or incorporate, at least in part, functionality described above for the components of conductivity detector 206 of FIG. 2 and PMU 210 of FIG. 2.

According to at least one example of the apparatus 700, the processing components 710 may include one or more of: circuit/modules 719 configured for detecting an electrically-conducting liquid (or for controlling the detection of electrically-conducting liquid performed by other components); circuit/modules 720 configured for detecting resistance signals from strips 752; circuit/modules 722 configured for converting resistance signals to resistivity values; circuits/modules 724 configured for converting resistivity values to conductivity values; circuits/modules 726 configured for adjusting conductivity values to compensate for temperature (as detected by temperature sensors 750); circuits/modules 728 configured for comparing conductivity values to thresholds to, e.g., detect the presence of aqueous metal ions or other impurities that indicate the presence of a liquid in the DSD that could damage the DSD; circuits/modules 730 for activating a failsafe mode (e.g., if the conductivity values exceed one or more thresholds); circuits/modules 732 configured for deactivating failsafe mode (e.g., once the conductivity values no longer exceed the thresholds); circuits/modules 734 configured for requesting laptop shutdown (e.g., upon entry into the failsafe mode); and circuits/modules 736 configured for identifying type of metal ions in electrically conducting liquids (if the device is programmed with different conductivity thresholds that distinguish among different types of metal ions or other impurities). Note that circuit/modules 720, 722, 724, 726, and 728 may be components of circuit/modules 719, which operate to detect the electrically-conducting liquid (or they may operate under the control of circuit/modules 719).

In at least some examples, means may be provided for performing the functions illustrated in FIG. 7 and/or other functions illustrated or described herein. For example, the means may include one or more of: means, such as circuit/modules 719, for detecting an electrically-conducting liquid (or for controlling the detection of electrically-conducting liquid performed by other components); means, such as circuit/modules 720, for detecting resistance signals from strips 752; means, such as circuit/modules 722, for converting resistance signals to resistivity values; means, such as circuits/modules 724, for converting resistivity values to conductivity values; means, such as circuits/modules 726, for adjusting conductivity values to compensate for temperature (as detected by temperature sensors 750); means, such as circuits/modules 728, for comparing conductivity values to thresholds to, e.g., detect the presence of aqueous metal ions or other impurities that indicate the presence of a liquid in the DSD that could damage the DSD; means, such as circuits/modules 730, for activating a failsafe mode (e.g., if the conductivity values exceed one or more thresholds); means, such as circuits/modules 732, for deactivating failsafe mode (e.g., once the conductivity values no longer exceed the thresholds); means, such as circuits/modules 734, for requesting laptop shutdown (e.g., upon entry into the failsafe mode); and means, such as circuits/modules 736, for identifying type of metal ions in electrically conducting liquids (if the device is programmed with difference conductivity thresholds that distinguish among different types of metal ions).

### Additional Exemplary Apparatus

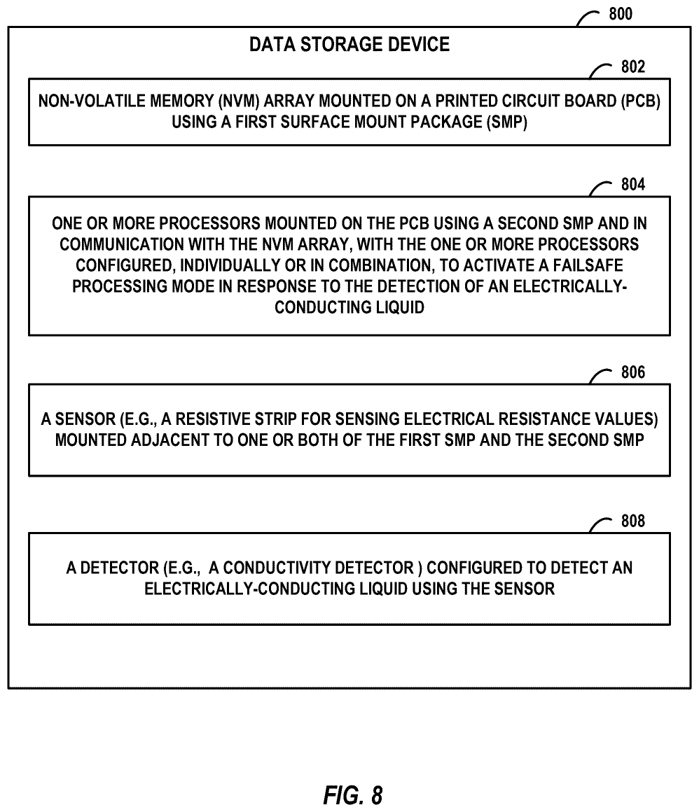

FIG. 8 broadly illustrates a data storage device 800 configured according to one or more aspects of the disclosure. The data storage device 800 includes an NVM array 802 mounted on a PCB using a first surface mount package (SMP). The NVM array 802 may be mounted, for example, to the PCB of the data storage device using a first BGA. The NVM array may be, for example, the NAND 216 of FIG. 2. The data storage device 800 also includes one or more processors mounted on the PCB using a second SMP and in communication with the NVM array. The one or more processors 804 are configured, individually or in combination, to activate a failsafe processing mode in response to the detection of an electrically-conducting liquid. A sensor 806 (e.g., a resistive strip for sensing electrical resistance values) is mounted adjacent to one or both of the first SMP and the second SMP. A detector 808 (such as a conductivity detector) is configured to detect the electrically-conducting liquid using the sensor, e.g., the detector 808 detects an electrically-conducting liquid at one or both of the first SMP and the second SMP. In some examples, one of the processors 804 may be the intelligent PMU 210 of FIG. 2. Another of the processors 804 may be the data storage controller 218 of FIG. 2. Note that the second SMP may include one or more SMPs including one or more BGAs.

As explained above, the failsafe mode prevents damage to the BGAs or other SMPs that might occur due to the presence of electrically-conducting liquids at the BGAs or other SMPs, such as liquids with aqueous metal ions or other conducting impurities.

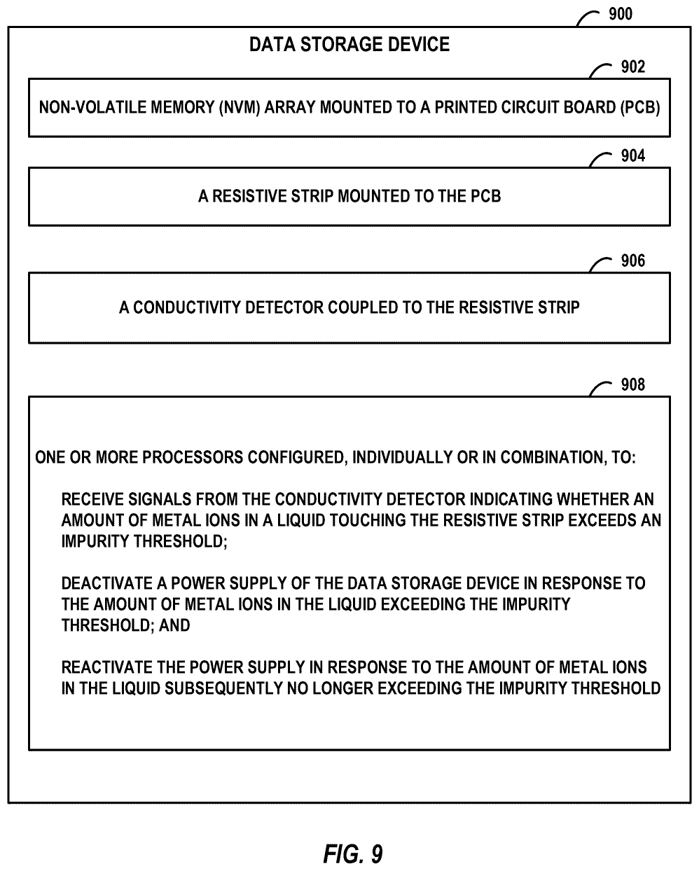

FIG. 9 broadly illustrates a data storage device 900 configured according to one or more aspects of the disclosure. The data storage device 900 includes an NVM array 902 mounted to a PCB. A resistive strip 904 is also mounted to the PCB (and may be mounted, for example, adjacent to the NVM array 902). A conductivity detector 906 is coupled to the resistive strip 904. One or more processors 908 are configured, individually or in combination, to: receive signals from the conductivity detector indicating whether an amount of metal ions in a liquid touching the resistive strip exceeds an impurity threshold (thus indicating, e.g., that the liquid is electrically-conducting); deactivate a power supply of the data storage device in response to the amount of metal ions in the liquid exceeding the impurity threshold; and reactivate the power supply in response to the amount of metal ions in the liquid subsequently no longer exceeding the impurity threshold.

The data storage device 900 may also include various other components such as a data storage controller, with the resistive strip 904 also mounted adjacent to such other devices to detect metal ions in liquids in or around those devices. Disconnection of the power supply prevents damage to the NVM array 902 and other devices that could occur due to the presence of the liquid with metal ions (e.g., corrosion or short circuiting).

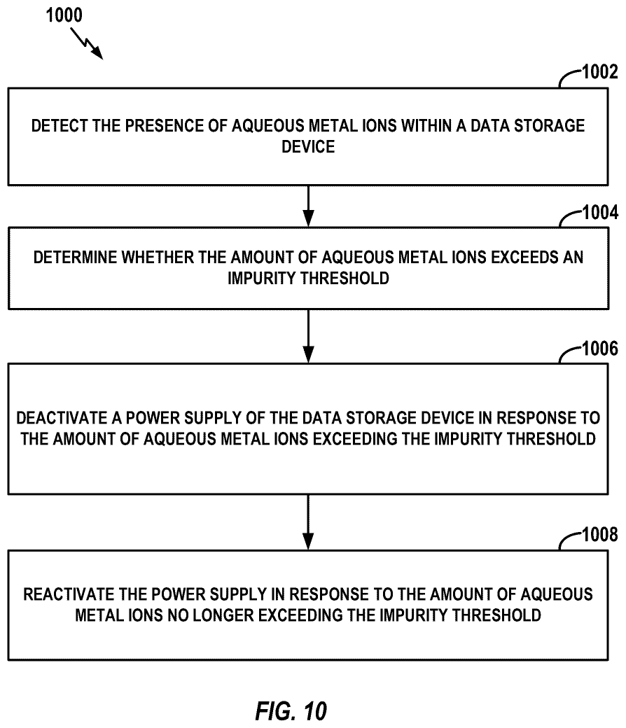

FIG. 10 broadly illustrates a method 1000 according to one or more aspects of the disclosure for use by a data storage device. At block 1002, a component of the data storage device (e.g., a conductivity detector) detects the presence of aqueous metal ions within the data storage device (e.g., in the vicinity of a NAND chip or data storage controller). At block 1004, a component of the data storage device (e.g., the conductivity detector) determines whether the amount (e.g., concentration) of aqueous metal ions exceeds an impurity threshold. At block 1006, a component of the data storage device (e.g., a failsafe PMU) deactivates a power supply of the data storage device in response to the amount of aqueous metal ions exceeding the impurity threshold. Later, at block 1008, a component of the data storage device (e.g., the failsafe PMU) reactivates the power supply in response to the amount of aqueous metal ions no longer exceeding the impurity threshold.

In some aspects, an apparatus may be provided that includes components for performing the operations of FIG. 10. For example, an apparatus may be provided that includes: means for detecting the presence of aqueous metal ions within the data storage device (e.g., the resistive strip 208 of FIG. 2); means determining whether the amount of aqueous metal ions exceeds an impurity threshold (e.g., the conductivity detector 206 of FIG. 2); means for deactivating a power supply of the data storage device in response to the amount of aqueous metal ions exceeding the impurity threshold (e.g., the relay 212 of FIG. 2); and means for reactivating the power supply in response to the amount of aqueous metal ions no longer exceeding the impurity threshold (e.g., the PMU 210 of FIG. 2).

Summarizing, in some examples, systems and procedures are provided to:
enable a failsafe power management mechanism that protects M.2 SSD NAND dies and data storage controller BOAs from water damage using various processing circuits (e.g., firmware), relays, PMUs, conductive detectors, and linear resistive strips.
measure water impurities such as metallic ions, salt, acids, and bases, which may cause corrosion or damage to the BGA pins.
determine if a water impurities level (e.g., metal ion level) is higher than a threshold value, and, if so, protect the SSD from short-circuiting by disconnecting the main power supply until the water is dried up or the impurities decrease to a safe level.
maintain power if water is deionized or distilled, since such water will not cause corrosion or short-circuits.
maintain backup power using an in-built lithium battery so that the presence or absence of liquids may be detected in a timely manner to, e.g., turn on power once the SSD is dry even if the SSD is not connected to the laptop or the laptop is turned off.
manage sending an IRQ signal to the laptop during a safe shutdown.

### Additional Aspects

At least some of the processing circuits described herein may be generally adapted for processing, including the execution of programming code stored on a storage medium. As used herein, the terms “code” or “programming” shall be construed broadly to include without limitation instructions, instruction sets, data, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

At least some of the processing circuits described herein may be arranged to obtain, process and/or send data, control data access and storage, issue commands, and control other desired operations. The processing circuits may include circuitry configured to implement desired programming provided by appropriate media in at least one example. For example, the processing circuits may be implemented as one or more processors, one or more controllers, and/or other structure configured to execute executable programming. Examples of processing circuits may include a general purpose processor, a digital signal processor (DSP), an ASIC, a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. At least some of the processing circuits may also be implemented as a combination of computing components, such as a combination of a controller and a microprocessor, a number of microprocessors, one or more microprocessors in conjunction with an ASIC and a microprocessor, or any other number of varying configurations. The various examples of processing circuits noted herein are for illustration and other suitable configurations within the scope of the disclosure are also contemplated.

Aspects of the subject matter described herein can be implemented in any suitable NVM, including NAND flash memory such as 3D NAND flash memory. More generally, semiconductor memory devices include working memory devices, such as DRAM or SRAM devices, NVM devices, ReRAM, EEPROM, flash memory (which can also be considered a subset of EEPROM), ferroelectric random access memory (FRAM), and MRAM, and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured. The semiconductor memory elements located within and/or over a substrate may be arranged in two or three dimensions, such as a two-dimensional memory structure or a three-dimensional memory structure.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements. One of skill in the art will recognize that the subject matter described herein is not limited to the two-dimensional and three-dimensional exemplary structures described but cover all relevant memory structures within the spirit and scope of the subject matter as described herein and as understood by one of skill in the art.

The examples set forth herein are provided to illustrate certain concepts of the disclosure. The apparatus, devices, or components illustrated above may be configured to perform one or more of the methods, features, or steps described herein. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Aspects of the present disclosure have been described above with reference to schematic flowchart diagrams and/or schematic block diagrams of methods, apparatus, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

The subject matter described herein may be implemented in hardware, software, firmware, or any combination thereof. As such, the terms “function,” “module,” and the like as used herein may refer to hardware, which may also include software and/or firmware components, for implementing the feature being described. In one example implementation, the subject matter described herein may be implemented using a computer readable medium having stored thereon computer executable instructions that when executed by a computer (e.g., a processor) control the computer to perform the functionality described herein. Examples of computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

The various features and processes described above may be used independently of one another, or may be combined in various ways. All possible combinations and sub-combinations are intended to fall within the scope of this disclosure. In addition, certain method, event, state, or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example embodiments. The example systems and components described herein may be configured differently than described. For example, elements may be added to, removed from, or rearranged compared to the disclosed example embodiments.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage, or mode of operation.

While the above descriptions contain many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents. Moreover, reference throughout this specification to “one embodiment,” “an embodiment,” “in one aspect,” or similar language means that a particular feature, structure, or characteristic described in connection with the embodiment is included in at least one embodiment of the present disclosure. Thus, appearances of the phrases “in one embodiment,” “in an embodiment,” “in one aspect,” and similar language throughout this specification may, but do not necessarily, all refer to the same embodiment, but mean “one or more but not all embodiments” unless expressly specified otherwise.

The terminology used herein is for the purpose of describing particular aspects only and is not intended to be limiting of the aspects. As used herein, the singular forms “a,” “an” and “the” are intended to include the plural forms as well (i.e., one or more), unless the context clearly indicates otherwise. An enumerated listing of items does not imply that any or all of the items are mutually exclusive and/or mutually inclusive, unless expressly specified otherwise. It will be further understood that the terms “comprises,” “comprising,” “includes” “including,” “having,” and variations thereof when used herein mean “including but not limited to” unless expressly specified otherwise. That is, these terms may specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may include one or more elements. In addition, terminology of the form “at least one of A, B, or C” or “A, B, C, or any combination thereof” or “one or more of A, B, or C” used in the description or the claims means “A or B or C or any combination of these elements.” For example, this terminology may include A, or B, or C, or A and B, or A and C, or A and B and C, or 2A, or 2B, or 2C, or 2A and B, and so on. As a further example, “at least one of: A, B, or C” or “one or more of A, B, or C” is intended to cover A, B, C, A-B, A-C, B-C, and A-B-C, as well as multiples of the same members (e.g., any lists that include AA, BB, or CC). Likewise, “at least one of: A, B, and C” or “one or more of A, B, or C” is intended to cover A, B, C, A-B, A-C, B-C, and A-B-C, as well as multiples of the same members. Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

As used herein, the term “determining” encompasses a wide variety of actions. For example, “determining” may include calculating, computing, processing, deriving, investigating, looking up (e.g., looking up in a table, a datastore, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

What is claimed is:

1. A data storage device, comprising:
a non-volatile memory (NVM) array mounted on a Printed Circuit Board (PCB) using a first surface mount package (SMP);
one or more processors mounted on the PCB using a second SMP and in communication with the NVM array;
a sensor mounted adjacent to one or both of the first SMP and the second SMP;
a detector configured to detect an electrically-conducting liquid using the sensor; and
wherein the one or more processors are configured, individually or in combination, to activate a failsafe processing mode in response to the detection of the electrically-conducting liquid.

2. The data storage device of claim 1,
wherein the sensor comprises at least one resistive linear strip; and
wherein the detector comprises a conductivity detector coupled to the at least one resistive linear strip.

3. The data storage device of claim 2, wherein the at least one resistive linear strip has a first portion adjacent to the first SMP and a second portion adjacent to the second SMP.

4. The data storage device of claim 2, wherein the conductivity detector is configured to detect the electrically-conducting liquid by being further configured to detect aqueous metal ions based on electrical resistance signals received from the at least one resistive linear strip.

5. The data storage device of claim 4, wherein the conductivity detector is configured to detect the aqueous metal ions by being further configured to:
receive the electrical resistance signals from the at least one resistive linear strip;
convert the electrical resistance signals to resistivity values;
convert the resistivity values to conductivity values; and
compare the conductivity values to one or more conductivity thresholds indicative of the presence of aqueous metal ions.

6. The data storage device of claim 5, further comprising a temperature sensor, and wherein the conductivity detector is further configured to adjust the conductivity values based on temperature values measured by the temperature sensor.

7. The data storage device of claim 1, wherein the one or more processors are further configured, in response to activation of the failsafe processing mode, to deactivate a power supply that provides power to the NVM array.

8. The data storage device of claim 7, wherein the one or more processors are further configured to reactivate the power supply in response to detection by the detector of an amount of the electrically-conducting liquid decreasing below a threshold indicative of a sufficient amount of drying.

9. The data storage device of claim 7, wherein the power is provided by a host.

10. The data storage device of claim 1, wherein the one or more processors are further configured, in response to activation of the failsafe processing mode, to send a signal to a host to request shutdown of the host.

11. The data storage device of claim 10, wherein the one or more processors are further configured to send a signal to the host to request reactivation of the host in response to detection by the detector of an amount of the electrically-conducting liquid decreasing below a threshold indicative of a sufficient amount of drying.

12. The data storage device of claim 1, further comprising a secondary power supply that remains active during the failsafe processing mode to provide power to at least the detector.

13. The data storage device of claim 1, wherein the data storage device comprises a solid state device (SSD) in the M.2 form factor.

14. The data storage device of claim 1, wherein one or both of the first SMP and the second SMP comprises a ball grid array (BGA).

15. A data storage device, comprising:
a non-volatile memory (NVM) array mounted to a printed circuit board (PCB);
a resistive strip mounted to the PCB;
a conductivity detector coupled to the resistive strip; and
one or more processors configured, individually or in combination, to:
receive signals from the conductivity detector indicating whether an amount of metal ions in a liquid touching the resistive strip exceeds an impurity threshold;
deactivate a power supply of the data storage device in response to the amount of metal ions in the liquid exceeding the impurity threshold; and
reactivate the power supply in response to the amount of metal ions in the liquid subsequently no longer exceeding the impurity threshold.

16. The data storage device of claim 15, wherein the conductivity detector is configured to detect the metal ions by being further configured to:
receive electrical resistance signals from the resistive strip;
convert the electrical resistance signals to resistivity values;
convert the resistivity values to conductivity values; and
compare the conductivity values to one or more conductivity thresholds indicative of the presence of metal ions in the liquid.

17. The data storage device of claim 16, further comprising a temperature sensor, and wherein the conductivity detector is further configured to adjust the conductivity values based on temperature values measured by the temperature sensor.

18. The data storage device of claim 15, wherein the resistive strip has a portion adjacent to the NVM array.

19. The data storage device of claim 15, further comprising a data storage controller, and
wherein the resistive strip has a portion adjacent to the data storage controller, and
wherein the data storage device comprises a solid state device (SSD) in the M.2 form factor.

20. A data storage device, comprising:
means for detecting aqueous metal ions within the data storage device;
means determining whether the aqueous metal ions exceed an impurity threshold;
means for deactivating a power supply of the data storage device in response to the aqueous metal ions exceeding the impurity threshold; and
means for reactivating the power supply in response to the aqueous metal ions no longer exceeding the impurity threshold.
